(19) United States
(12) Patent Application Publication
(10) Pub. No.: US 2008/0317943 A1
(43) Pub. Date: Dec. 25, 2008

(54) METHOD FOR FORMING PATTERN, METHOD FOR MANUFACTURING ELECTRO-OPTICAL DEVICE, AND METHOD FOR MANUFACTURING ELECTRONIC DEVICE

(75) Inventor: Toshimitsu HIRAI, Hokuto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/115,582

(22) Filed: May 6, 2008

(30) Foreign Application Priority Data
Jun. 20, 2007 (JP) 2007-162426

(51) Int. Cl. B05D 5/12

(52) U.S. Cl. 427/64

(57) ABSTRACT

A method for forming a pattern includes: a) applying a droplet containing a lyophobic material to a substrate having a lyophilic part that is lyophillic with respect to a functional liquid so as to form a lyophobic part that is lyophobic with respect to the functional liquid and including a plurality of lyophobic parts; and b) applying the functional liquid to the lyophilic part positioned between the lyophobic parts. In the method, the lyophobic material includes at least one of a silane compound, a compound including a fluoroalkyl group, and a resin containing fluorine.

### BACKGROUND

1. Technical Field

The present invention relates to a method for forming a pattern, a method for manufacturing an electro-optical device, and a method for manufacturing an electronic device.

2. Related Art

In a case where a pattern is formed by a droplet discharge method (ink-jetting), a droplet of a liquid material (ink) is discharged and landed on a predetermined position of a substrate so as to form a pattern. In such a case that a droplet is discharged and landed on a substrate as above, the droplet may excessively spread or separate depending on a property of a surface of the substrate. In this case, a desired wiring pattern can not be obtained disadvantageously.

Therefore, JP-A-2004-200244, for example, discloses such technique that a lyophobic treatment is performed on a surface to be a pattern forming face of a substrate and thus the surface on which the lyophobic treatment is performed is irradiated with an ultraviolet laser beam which passes a photocatalyst so as to form a lyophilic pattern.

JP-A-11-344804, for example, discloses such technique that after a lyophobic lower layer containing a photocatalyst is applied on a substrate on which a pattern is to be formed, the substrate is exposed to light through a mask so as to make only the exposed part lyophilic.

However, techniques as the above-mentioned related art have the following problems.

The techniques mentioned above employ an expensive exposure device, photo-mask, and laser light source so as to cause a cost increase. In addition, a lyophobic material required only for a part that is not patterned is applied on a whole surface of the substrate, being undesirable for material reduction.

### SUMMARY

An advantage of the present invention is to provide a method for forming a pattern, a method for manufacturing an electro-optical device, and a method for manufacturing an electronic device. By the method for forming a pattern, a high quality pattern can be formed without increasing a cost.

Aspects of the invention will be described below.

A method for forming a pattern according to a first aspect of the invention, includes: a) applying a droplet containing a lyophobic material to a substrate having a lyophilic part that is lyophillic with respect to a functional liquid so as to form a lyophobic part that is lyophobic with respect to the functional liquid and includes a plurality of lyophobic parts; and b) applying the functional liquid to the lyophilic part positioned between the lyophobic parts. In the method, the lyophobic material includes at least one of a silane compound, a compound including a fluoroalkyl group, and a resin containing fluorine.

In the method of the first aspect, a droplet containing the lyophobic material including at least one of a silane compound, a compound including a fluoroalkyl group, and a resin containing fluorine is applied to form a pattern, being able to form the lyophobic part in a desired region. Further, in the method, the functional liquid is applied to the lyophilic part between the lyophobic parts. The functional liquid is repelled by the lyophobic parts, so that a pattern corresponding to an arrangement of the lyophilic part can be formed with high accuracy. Furthermore, in the method, the lyophobic parts are patterned to be formed by applying the droplet containing the lyophobic material in the step a). Therefore, the method does not require an expensive exposure device, photo mask, laser light source, and the like, being able to prevent a cost increase.

In the method of the first aspect, the lyophobic material may be a resin containing fluorine in a side chain thereof.

In the method of the aspect, the silane compound may be a self-assembled film.

Further, in the method of the aspect, the lyophobic part may be formed on a surface of the substrate with a self-assembled film that is made of a compound including the fluoroalkyl group.

Furthermore, in the method of the aspect, the lyophobic part may be formed on the surface of the substrate with a self-assembled film including an alkyl group and hydrogen.

In the method of the aspect, the functional liquid may be a liquid material obtained by dissolving a pattern forming material in a polar solvent.

Accordingly, in a case where the lyophobic material is a silane compound or a compound including a fluoroalkyl group, the lyophobic property of the lyophobic parts can be efficiently expressed with respect to the functional liquid that is applied.

According to the method of the aspect, a droplet of the functional liquid may be applied to the lyophilic part, in the step b).

Accordingly, in the aspect, both of the step a) and the step b) can be carried out by droplet discharging, so that facilities required for the steps can be shared, being able to decrease the production cost.

In the method of the aspect, the functional liquid may contain a conductive material.

The conductive material may contain at least one of gold, silver, copper, palladium, nickel, and indium tin oxide (ITO).

Accordingly, an excellent conductive pattern can be formed without a cost increase.

In the method of the aspect, the functional liquid may contain a plating catalyst material.

In the aspect, a plating treatment is conducted with a plating catalyst that is formed without a cost increase, being able to form a dense and excellent pattern.

A method for manufacturing an electro-optical device according to a second aspect of the invention, includes forming a pattern by the method for forming a pattern according to the first aspect.

A method for manufacturing an electronic device according to a third aspect of the invention, includes forming a pattern by the method for forming a pattern according to the first aspect.

In the second and third aspects, an electro-optical device and an electronic device having an excellent pattern can be manufactured without a cost increase.

In the second aspect, it is preferable that the electro-optical device be an electromagnetic wave shield including a mesh part which is formed in a mesh shape with a conductive wire and a frame part which is formed around a periphery of the mesh part with the conductive wire, and the mesh part and the frame part be formed by the method for forming a pattern.

Accordingly, an electromagnetic wave shield having an excellent pattern can be manufactured without a cost increase. Further, in the second aspect, a discharge amount and a discharge pitch of the lyophobic droplet are adjusted so as to adjust a width of the lyophobic part, that is, a width of the wire of the mesh part. Thus, a shield property and an aperture rate can be easily adjusted.

### BRIEF DESCRIPTION OF THE DRAWINGS

The invention will be described with reference to the accompanying drawings wherein like numbers reference like elements.

FIG. 1 is a schematic view showing a structure of a droplet discharge device.

FIG. 2 is a sectional view of a droplet discharge head 301.

FIGS. 3A and 3B are diagrams showing a lyophobic part and a wiring pattern formed on a substrate.

FIGS. 4A and 4B show a step for forming a pattern.

FIGS. 5A and 5B show a step for forming a pattern.

FIGS. 6A and 6B show a step for forming a pattern.

FIG. 7 is a table showing a relation of a contact angle of a lyophobic part and a lyophilic part, a contrast, and a drawing result.

FIG. 8 is an exploded perspective view showing a plasma display device.

FIGS. 9A and 9B are diagrams showing a procedure to form a display electrode and a bus electrode.

FIGS. 10A and 10B are diagrams showing a procedure to form a display electrode and a bus electrode.

FIGS. 11A and 11B are diagrams showing a procedure to form a display electrode and a bus electrode.

FIGS. 12A and 12B are diagrams showing an electromagnetic wave shield.

FIG. 13 is a plan view illustrating a liquid crystal display viewed from a counter substrate.

FIG. 14 is a sectional view taken along the line H-H′ of FIG. 13.

FIG. 15 is a diagram showing an equivalent circuit of the liquid crystal display.

FIG. 16 is a partially enlarged view of the liquid crystal display.

FIG. 17 is a partially enlarged view of a liquid crystal display of another embodiment.

FIG. 18 is an exploded perspective view showing a noncontact card medium.

FIGS. 19A, 19B, and 19C illustrate specific examples of electronic devices.

### DESCRIPTION OF EXEMPLARY EMBODIMENTS

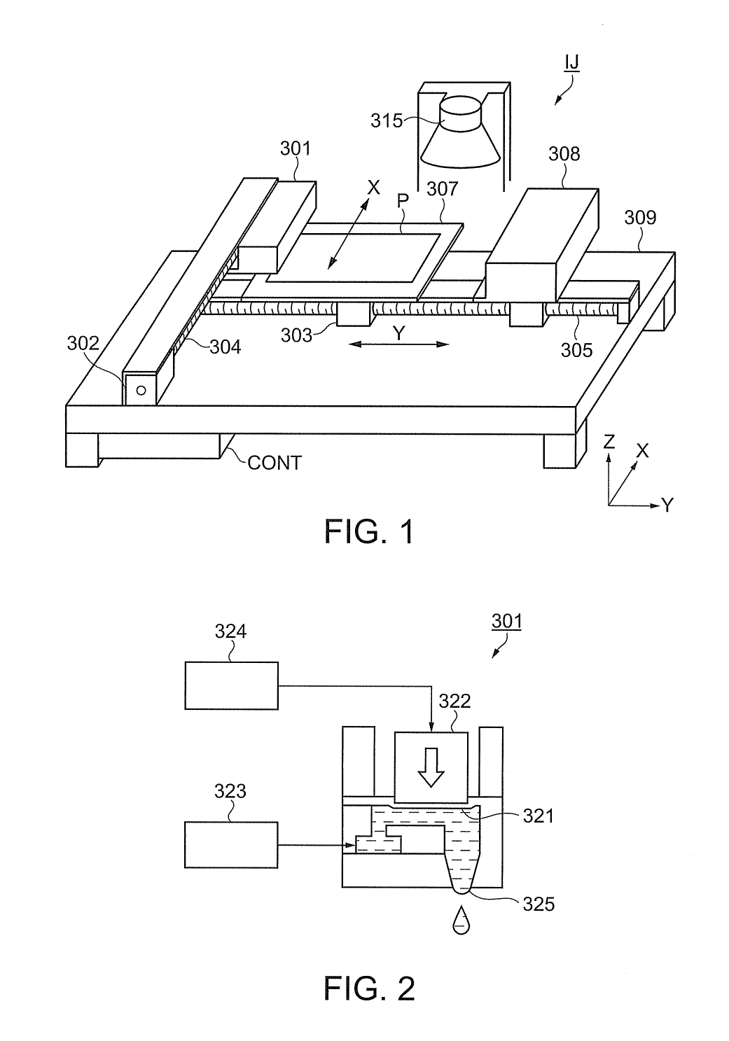

Embodiments of a method for forming a pattern, a method for manufacturing an electro-optical device, and a method for manufacturing an electronic device of the present invention will be described with reference to FIGS. 1 through 19C.

Note that scales of members in the figures referred to hereinafter are adequately changed so that they can be recognized.

### First Embodiment

(Droplet Discharge Device)

First, a droplet discharge device used in a method for forming a pattern according to a first embodiment will be described.

FIG. 1 is a schematic view showing a structure of a droplet discharge device.

A droplet discharge device (inkjet device) IJ that discharges (drops) a droplet to a substrate P from a droplet discharge head is provided with a droplet discharge head 301, an X-direction drive axis 304, a Y-direction guide axis 305, a controller CONT, a stage 307, a cleaning mechanism 308, a base 309, and a heater 315. The stage 307 supports the substrate P to which an ink (a liquid material) is provided by the droplet discharge device IJ and includes a fixing mechanism (not shown) for fixing the substrate P to a reference position.

The droplet discharge head 301 is a multi-nozzle type droplet discharge head including a plurality of discharge nozzles. The longitudinal direction of the droplet discharge head 301 corresponds to the X-axis direction. The plurality of discharge nozzles are disposed at a fixed interval in the X-axis direction on a lower surface of the droplet discharge head 301. An ink containing conductive fine particles is discharged from the discharge nozzles of the droplet discharge head 301 to the substrate P that is supported by the stage 307.

To the X-direction drive axis 304, an X-direction drive motor 302 is coupled. The X-direction drive motor 302 is a stepping motor, for example, and rotates the X-direction drive axis 304 when receiving a driving signal for the X-direction from the controller CONT. By the rotation of the X-direction drive axis 304, the droplet discharge head 301 moves in the X-axis direction.

The Y-direction guide axis 305 is fixed with respect to the base 309 so as not to move. The stage 307 is provided with a Y-direction drive motor 303. The Y-direction drive motor 303 is a stepping motor, for example, and moves the stage 307 in the Y-direction when receiving a driving signal for the Y-direction from the controller CONT.

The controller CONT supplies the droplet discharge head 301 with a voltage for controlling a droplet discharge. The controller CONT also supplies the X-direction drive motor 302 with a drive pulse signal for controlling the movement of the droplet discharge head 301 in the X-direction, and supplies the Y-direction drive motor 303 with a drive pulse signal for controlling the movement of the stage 307 in the Y-direction.

The cleaning mechanism 308 cleans the droplet discharge head 301. The cleaning mechanism 308 is provided with a Y-direction drive motor which is not shown. By driving the Y-direction drive motor, the cleaning mechanism 308 is moved along the Y-direction guide axis 305. The movement of the cleaning mechanism 308 is also controlled by the controller CONT.

The heater 315 that is means to subject the substrate P under a heat treatment by a lamp annealing in this case evaporates and dries solvents contained in a liquid material that is applied on the substrate P. Application and interruption of the power source of the heater 315 are controlled by the controller CONT, as well.

The droplet discharge device IJ discharges droplets to the substrate P while relatively scanning the droplet discharge head 301 with respect to the stage 307 which supports the substrate P. In the following description, the X-direction is referred to as a non-scan direction and the Y-direction perpendicular to the X-direction is referred to as a scan direction.

Accordingly, the discharge nozzles of the droplet discharge head 301 are arranged in the X-direction that is the non-scan direction at a fixed interval. While the droplet discharge head 301 is disposed at right angle to the moving direction of the substrate P in FIG. 1, the angle of the droplet discharge head 301 may be adjusted so as to intersect the moving direction of the substrate P. Thus, a pitch between the nozzles can be adjusted by adjusting the angle of the droplet discharge head 301. In addition, the distance between the substrate P and a nozzle surface may also be arbitrarily adjusted.

FIG. 2 is a sectional view of the droplet discharge head 301.

In the droplet discharge head 301, a piezo element 322 is disposed adjacent to a liquid chamber 321 that stores a liquid material (ink such as for wiring lines). To the liquid chamber 321, a liquid material is supplied through a liquid material supply system 323 including a material tank that stores the liquid material.

The piezo element 322 is coupled to a driving circuit 324. A voltage is applied to the piezo element 322 through the driving circuit 324 so as to deform the piezo element 322, and accordingly the liquid chamber 321 is deformed to discharge the liquid material from a nozzle 325.

In this case, a strain amount of the piezo element 322 is controlled by changing a value of applied voltage. In addition, a strain velocity of the piezo element 322 is controlled by changing a frequency of applied voltage. The droplet discharge employing this piezo system applies no heat to a material, advantageously giving less effect on a composition of the material.

Examples of a discharging technique of a droplet discharging method include: charge control, pressurized vibration, electrothermal convertion, and electrostatic attraction as well as the above-mentioned electromechanical convertion. The charge control is a method that applies an electric charge to a material by a charge electrode so as to control a flying direction of the material with a deflecting electrode, discharging the material from a discharge nozzle. The pressurized vibration is a method that, for example, applies ultra-high pressure of approximately 30 kg/cm² to a material so as to discharge the material at the tip of a nozzle. If no control voltage is applied, the material moves straight ahead so as to be discharged from a discharge nozzle. If a control voltage is applied, electrostatic repelling occurs within the material so as to disperse the material, whereby no material is discharged from the nozzle.

The electrothermal conversion is a method that evaporates a material rapidly with a heater provided in a space storing a material so as to produce bubbles, and thus discharges the material out of the space by using pressure of the bubbles. The electrostatic attraction is a method that applies micro pressure to a space storing a material so as to form a meniscus of the material at a discharge nozzle and then applies electrostatic attraction in this state so as to pull out the material. Other than these methods, a method that uses a fluid viscosity change caused by an electric field, and a method that uses electric discharge sparks can also be employed. The droplet discharge has an advantage of adequately disposing a material in a desired amount to a desired position with little waste of the material. An amount of one droplet of the liquid material (fluid) discharged by the droplet discharge method is, for example, from 1 to 300 nanograms.

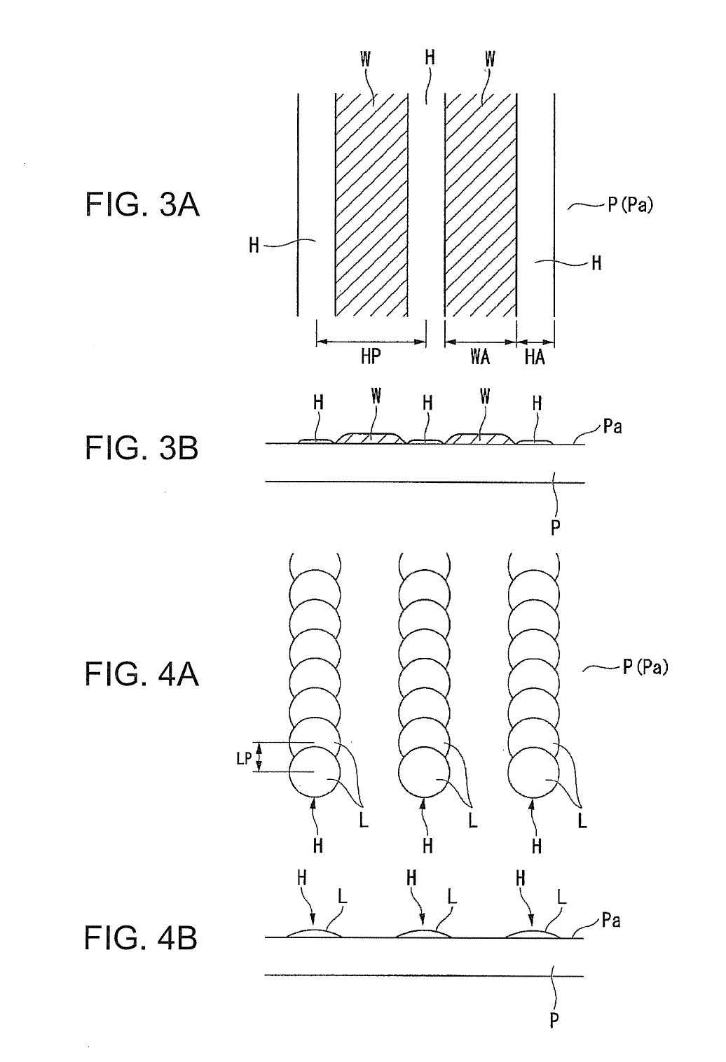

Next, a method for forming a pattern with the droplet discharge device IJ described above will be described with reference to FIGS. 3A to 7.

Referring to FIGS. 3A and 3B, such case will be described that a plurality of lyophobic parts H (three parts in the embodiment) are formed in a manner having a gap therebetween so as to form a stripe shape on a substrate P of which at least a surface Pa is a lyophilic part having a lyophilic property, and a wiring pattern (a pattern) W is formed between the lyophobic parts H. Here, the lyophobic part is a region that has a predetermined value or more of a contact angle with respect to a droplet containing a conductive material (hereinafter, referred to as a droplet for a pattern), and the lyophilic part is a region that has a predetermined value or less of a contact angle with respect to the droplet containing the conductive material, in the present embodiment.

Examples of the substrate P include various types of materials such as glass, quartz glass, a Si wafer, a plastic film, and a metal plate; and these material substrates provided with a semiconductor film, a metal film, a dielectric film, or an organic film as a base layer on their surfaces.

The method for forming a pattern according to the present embodiment is such that an ink for a wiring pattern described above is applied to the substrate P so as to form the pattern W for wiring. The method nearly includes a surface treatment step, a lyophobic part forming step, a material disposing step, and a thermal/optical treatment step.

Hereinafter, each of these steps is described in detail.

(Surface Treatment Step)

In the surface treatment step, a cleaning treatment is conducted with respect to the surface Pa of the substrate P so as to enhance the lyophilic property thereof.

In a case where the substrate P is a glass substrate, for example, the surface thereof has a lyophilic property. By the surface treatment, the lyophilic property is further enhanced.

In particular, examples of the cleaning treatment conducted in the surface treatment step include: UV excimer cleaning, low pressure mercury lamp cleaning, O₂ plasma cleaning, acid cleaning that employs HF or sulfuric acid, alkali cleaning, ultrasonic cleaning, megasonic cleaning, corona cleaning, glow cleaning, scrub cleaning, ozone cleaning, hydrogen water cleaning, micro-bubble cleaning, and fluorine cleaning.

If the contact angle of the surface (lyophilic part) Pa with respect to the droplet for a pattern excesses 25 degrees, a bulge (collection of droplets) easily occurs. On the other hand, the contact angle is 20 degrees or less, no bulge occurs. Therefore, a cleaning treatment condition is adjusted so as to make the contact angle of the surface Pa of the substrate with respect to a droplet for a pattern be 20 degrees or less, in the present embodiment.

In particular, in a case where the cleaning treatment is the UV excimer cleaning, for example, the lyophilic property (contact angle) can be adjusted by adjusting a combination of heat treatment (heating); and irradiating time, intensity, and wavelength of UV light (ultra violet light). In a case where the cleaning treatment is the O₂ plasma cleaning, the lyophilic property (contact angle) can be adjusted by adjusting plasma treatment time. Even if foreign substance such as an organic matter is attached on the surface Pa, this cleaning treatment can remove the substance, being able to maintain cleanness and the lyophilic property of the surface Pa.

(Lyophobic Part Forming Step)

The lyophobic parts H will be next formed on a predetermined region (an area surrounding a region formed by the pattern W) of the surface Pa on the substrate P on which the cleaning treatment (lyophilic treatment) has been conducted.

In particular, a liquid droplet containing a material that has a lyophobic property with respect to a droplet for a pattern (hereinafter, referred to as a lyophobic droplet) is discharged from the droplet discharge head 301 of the droplet discharge device IJ described above so as to apply the droplet to a predetermined region on the substrate P.

As a material having a lyophobic property, a silane compound, a compound including a fluoroalkyl group, a fluorine resin (a resin containing fluorine), or these commixture can be used.

As the silane compound, one or two or more silane compounds expressed by a following general formula (1) can be used.

R¹Si X¹mX²₍3-m) (1)

(In the formula, R¹ indicates an organic group, X¹ and X² indicate —OR², —R², and —C¹, R² indicates an alkyl group having from 1 to 4 carbons, and m indicates integer numbers from 1 to 3.)

In the silane compound expressed by the general formula (1), a silane atom is substituted by an organic group, and other bonds are substituted by an alkoxy group, an alkyl group, or a chlorine group. Examples of the organic group R¹ include: a phenyl group, a benzyl group, a phenethyl group, a hydroxyphenyl group, a chlorophenyl group, an aminophenyl group, a naphthyl group, an anthrenyl group, a pyrenyl group, a thienyl group, a pyrrolyl group, a cyclohexyl group, a cyclohexenyl group, a cyclopentyl group, a cyclopentenyl group, a pyridinyl group, a methyl group, an ethyl group, an n-propyl group, an isopropyl group, an n-butyl group, an isobutyl group, a sec-butyl group, a tert-butyl group, an octadecyl group, an n-octyl group, a chloromethyl group, a methoxyethyl group, a hydroxyethyl group, an aminoethyl group, a cyano group, a mercaptopropyl group, a vinyl group, an allyl group, an acryloxyethyl group, a methacryloxyethyl group, a glycidoxypropyl group, and an acetoxy group.

An example of X¹ is a functional group for forming an alkoxy group, a chlorine group, a Si—O—Si bond, and the like, and X¹ is hydrolyzed with water to be removed as alcohol or acid. Examples of the alkoxy group includes: a methoxy group, an ethoxy group, an n-propoxy group, an isopropoxy group, an n-butoxy group, an isobutoxy group, a sec-butoxy group, and a tert-butoxy group.

The number of carbons of R² is preferably within a range from 1 to 4 from the point of view that alcohol to be removed has a relatively small molecular amount so as to be able to be easily removed and therefore density of a film to be formed can be prevented from being lowered.

Examples of the silane compound expressed in the general formula (I) include: dimethyldimethoxysilane, diethyldiethoxysilane, 1-propenylmethyldichlorosilane, propyldimethylchlorosilane, propylmethyldichlorosilane, propyltrichlorosilane, propyltriethoxysilane, propyltrimethoxysilane, styrylethyltrimethoxysilane, tetradecyltrichlorosilane, 3-thiocyanatepropyltriethoxysilane, p-tolyldimethylchlorosilane, p-tolylmethyldichlorosilane, p-tolyltrichlorosilane, p-tolyltrimethoxysilane, p-tolyltriethoxysilane, di-n-propyldi-n-propoxysilan, diisopropyldiisopropoxysilane, di-n-butyldi-n-butyloxysilane, di-sec-butyldi-sec-butyloxysilane, di-t-butyldi-t-butyloxysilane, octadecyltrichlorosilane, octadecylmethyldiethoxysilane, octadecyltriethoxysilane, octadecyltrimethoxysilane, octadecyldimethylchlorosilane, octadecylmethyldichlorosilane, octadecylmethoxydichlorosilane, 7-octenyldimethylchlorosilane, 7-octenyltrichlorosilane, 7-octenyltrimethoxysilane, octylmethyldichlorosilane, octyldimethylchlorosilane, octyltrichlorosilane, 10-undecenyldimethylchlorosilane, undecyltrichlorosilane, vinyldimethylchlorosilane, methyloctadecyldimethoxysilane, methyldodecyldiethoxysilane, methyloctadecyldimethoxysilane, methyloctadecyldiethoxysilane, n-octylmethyldimethoxysilane, n-octylmethyldiethoxysilane, triacontyldimethylchlorosilane, triacontyltrichlorosilane, methyltrimethoxysilane, methyltriethoxysilane, methyltri-n-propoxysilane, methylisopropoxysilane, methyl-n-butyloxysilane, methyltri-sec-butyloxysilane, methyltri-t-butyloxysilane, ethyltrimethoxysilane, ethyltriethoxysilane, ethyltri-n-propoxysilane, ethylisopropoxysilane, ethyl-n-butyloxysilane, ethyltri-sec-butyloxysilane, ethyltri-t-butyloxysilane, n-propyltrimethoxysilane, isobutyltrimethoxysilane, n-hexyltrimethoxysilane, hexadecyltrimethoxysilane, n-octyltrimethoxysilane, n-dodecyltrimethoxysilane, n-octadecyltrimethoxysilane, n-propyltriethoxysilane, isobutyltriethoxysilane, n-hexyltriethoxysilane, hexadecyltriethoxysilane, n-octyltriethoxysilane, n-dodecyltriethoxysilane, n-octadecyltriethoxysilane, 2-[2-(trichlorosilyl)ethyl]pyridine, 4-[2-(trichlorosilyl)ethyl]pyridine, diphenyldimethoxysilane, diphenyldiethoxysilane, 1,3-(trichlorosilylmethyl)heptacosane, dibenzyldimethoxysilane, dibenzyldiethoxysilane, phenyltrimethoxysilane, phenylmethyldimethoxysilane, phenyldimethylmethoxysilane, phenyldimethoxysilane, phenyldiethoxysilane, phenylmethyldiethoxysilane, phenyldimethylethoxysilane, benzyltriethoxysilane, benzyltrimethoxysilane, benzylmethyldimethoxysilane, benzyldimethylmethoxysilane, benzyldimethoxysilane, benzyldiethoxysilane, benzylmethyldiethoxysilane, benzyldimethylethoxysilane, benzyltriethoxysilane, dibenzyldimethoxysilane, dibenzyldiethoxysilane, 3-acetoxypropyltrimethoxysilane, 3-acryloxypropyltrimethoxysilane, allyltrimethoxysilane, allyltriethoxysilane, 4-aminobutyltriethoxysilane, (aminoethylaminomethyl)phenethyltrimethoxysilane, N-(2-aminoethyl)-3-aminopropylmethyldimethoxysilane, N-(2-aminoethyl)-3-aminopropyltrimethoxysilane, 6-(aminohexylaminopropyl)trimethoxysilane, p-aminophenyltrimethoxysilane, p-aminophenylethoxysilane, m-aminophenyltrimethoxysilane, m-aminophenylethoxysilane, 3-aminopropyltrimethoxysilane, 3-aminopropyltriethoxysilane, ω-aminoundecyltrimethoxysilane, amyltriethoxysilane, 5-(bicycloheptenyl)triethoxysilane, bis(2-hydroxyethyl)-3-aminopropyltriethoxysilane, 8-bromooctyltrimethoxysilane, bromophenyltrimethoxysilane, 3-bromopropyltrimethoxysilane, n-butyltrimethoxysilane, 2-chloromethyltriethoxysilane, chloromethylmethyldiethoxysilane, chloromethylmethyldiisopropoxysilane, p-(chloromethyl)phenyltrimethoxysilane, chloromethyltriethoxysilane, chlorophenyltriethoxysilane, 3-chloropropylmethyldimethoxysilane, 3-chloropropyltriethoxysilane, 3-chloropropyltrimethoxysilane, 2-(4-chlorosulfonylphenyl)ethyltrimethoxysilane, 2-cyanoethyltriethoxysilane, 2-cyanoethyltrimethoxysilane, cyanomethylphenethyltriethoxysilane, 3-cyanopropyltriethoxysilane, 2-(3-cyclohexenyl)ethyltrimethoxysilane, 2-(3-cyclohexenyl)ethyltriethoxysilane, 3-cyclohexenyltrichlorosilane, 2-(3-cyclohexenyl)ethyltrichlorosilane, 2-(3-cyclohexenyl)ethyldimethylchlorosilane, 2-(3-cyclohexenyl)ethylmethyldichlorosilane, cyclohexyldimethylchlorosilane, cyclohexylethyldimethoxysilane, cyclohexylmethyldichlorosilane, cyclohexylmethyldimethoxysilane, (cyclohexylmethyl)trichlorosilane, cyclohexyltrichlorosilane, cyclohexyltrimethoxysilane, cyclooctyltrichlorosilane, (4-cyclooctenyl)trichlorosilane, cyclopentyltrichlorosilane, cyclopentyltrimethoxysilane, 1,1-diethoxy-1-silacyclopenta-3-ene, 3-(2,4-dinitrophenylamino)propyltriethoxysilane, (dimethylchlorosilyl)methyl-7,7-dimethylnorpinane, (cyclohexylaminomethyl)methyldiethoxysilane, (3-cyclopentadienylpropyl)triethoxysilane, (N,N-diethyl-3-aminopropyl)trimethoxysilane, 2-(3,4-epoxycyclohexyl)ethyltrimethoxysilane, 2-(3,4-epoxycyclohexyl)ethyltriethoxysilane, (furfuryloxymethyl)triethoxysilane, 2-hydroxy-4-(3-triethoxypropoxy)diphenylketone, 3-(p-methoxyphenyl)propylmethyldichlorosilane, 3-(p-methoxyphenyl)propyltrichlorosilane, p-(methylphenethyl)methyldichlorosilane, p-(methylphenethyl)trichlorosilane, p-(methylphenethyl)dimethylchlorosilane, 3-morpholinopropyltrimethoxysilane, (3-glycidoxypropyl)methyldiethoxysilane, 3-glycidoxypropyltrimethoxylsilane, 1,2,3,4,7,7,-hexachloro-6-methyldiethoxysilyl-2-norbornene, 1,2,3,4,7,7,-hexachloro-6-triethoxysilyl-2-norbornene, 3-iodpropyltrimethoxysilane, 3-isocyanatepropyltriethoxysilane, (mercaptomethyl)methyldiethoxysilane, 3-mercaptopropylmethyldimethoxysilane, 3-mercaptopropyldimethoxysilane, 3-mercaptopropyltriethoxysilane, 3-methacryloxypropylmethyldiethoxysilane, 3-methacryloxypropyltrimethoxysilane, methyl[2-(3-trimethoxysilylpropylamino)ethylamino]-3-propionate, 7-octenyltrimethoxysilane, R—N-α-phenethyl-N′-triethoxysilylpropylurea, S—N-α-phenethyl-N′-triethoxysilylpropylurea, phenethyltrimethoxysilane, phenethylmethyldimethoxysilane, phenethyldimethylmethoxysilane, phenethyldimethoxysilane, phenethyldiethoxysilane, phenethylmethyldiethoxysilane, phenethyldimethylethoxysilane, phenethyltriethoxysilane, (3-phenylpropyl)dimethylchlorosilane, (3-phenylpropyl)methyldichlorosilane, N-phenylaminopropyltrimethoxysilane, N-(triethoxysilylpropyl)dansylamide, N-(3-triethoxysilylpropyl)-4,5-dihydroimidazole, 2-(triethoxysilylethyl)-5-(chloroacetoxy)bicycloheptane, (S)—N-triethoxysilylpropyl-O-menthocarbamate, 3-(triethoxysilylpropyl)-p-nitrobenzamide, 3-(triethoxysilyl)propylsuccinicanhydride, N-[5-(trimethoxysilyl)-2-aza-1-oxo-pentyl]caprolactam, 2-(trimethoxysilylethyl)pyridine, N-(trimethoxysilylethyl)benzyl-N,N,N-trimethylammonium chloride, phenylvinyldiethoxysilane, 3-thiocyanatepropyltriethoxysilane, (tridecafluoro-1,1,2,2,-tetrahydrooctyl)triethoxysilane, N-[3-(triethoxysilyl)propyl]phthalamic acid, (3,3,3-trifluoropropyl)methyldimethoxysilane, (3,3,3-trifluoropropyl)trimethoxysilane, 1-trimethoxysilyl-2-(chloromethyl)phenylethane, 2-(trimethoxysilyl)ethylphenylsulfonylazide, 6-trimethoxysilylethyl-2-pyridine, trimethoxysilylpropyldiethylenetriamine, N-(3-trimethoxysilylpropyl)pyrrole, N-trimethoxysilylpropyl-N,N,N-tributylammonium bromide, N-trimethoxysilylpropyl-N,N,N-tributylammonium chloride, N-trimethoxysilylpropyl-N,N,N-trimethylammonium chloride, vinylmethyldiethoxysilane, vinyltriethoxysilane, vinyltrimethoxysilane, vinylmethyldimethoxysilane, vinyldimethylmethoxysilane, vinyldimethylethoxysilane, vinylmethyldichlorosilane, vinylphenyldichlorosilane, vinylphenyldiethoxysilane, vinylphenyldimethylsilane, vinylphenylmethylchlorosilane, vinyltriphenoxysilane, vinyltris-t-butoxysilane, adamantylethyltrichlorosilane, allylphenyltrichlorosilane, (aminoethylaminomethyl)phenethyltrimethoxysilane, 3-aminophenoxydimethylvinylsilane, phenyltrichlorosilane, phenyldimethylchlorosilane, phenylmethyldichlorosilane, benzyltrichlorosilane, benzyldimethylchlorosilane, benzylmethyldichlorosilane, phenethyldiisopropylchlorosilane, phenethyltrichlorosilane, phenethyldimethylchlorosilane, phenethylmethyldichlorosilane, 5-(bicycloheptenyl)trichlorosilane, 5-(bicycloheptenyl)triethoxysilane, 2-(bicycloheptyl)dimethylchlorosilane, 2-(bicycloheptyl)trichlorosilane, 1,4-bis(trimethoxysilylethyl)benzene, bromophenyltrichlorosilane, 3-phenoxypropyldimethylchlorosilane, 3-phenoxypropyltrichlorosilane, t-butylphenylchlorosilane, t-butylphenylmethoxysilane, t-butylphenyldichlorosilane, p-(t-butyl)phenethyldimethylchlorosilane, p-(t-butyl)phenethyltrichlorosilane, 1,3-(chlorodimethylsilylmethyl)heptacosane, ((chloromethyl)phenylethyl)dimethylchlorosilane, ((chloromethyl)phenylethyl)methyldichlorosilane, ((chloromethyl)phenylethyl)trichlorosilane, ((chloromethyl)phenylethyl)trimethoxysilane, chlorophenyltrichlorosilane, 2-cyanoethyltrichlorosilane, 2-cyanoethylmethyldichlorosilane, 3-cyanopropylmethyldiethoxysilane, 3-cyanopropylmethyldichlorosilane, 3-cyanopropyldimethylethoxysilane, 3-cyanopropylmethyldichlorosilane, and 3-cyanopropyltrichlorosilane.

The silane compound containing fluorine (lyophobic silane compound) may be an alkylsilane compound containing fluorine. That is, the compound has a structure in which perfluoroalkyl structure expressed as CₙF₂ₙ₊₁ and silicon are bonded. The compound expressed by a following general formula (2) can be exemplified. In the general formula (2), n indicates an integer number from 1 to 18, m indicates an integer number from 2 to 6, X¹ and X² indicate —OR², —R², and —C¹, R² included in X¹ and X² indicates an alkyl group having from 1 to 4 carbons, and a indicates an integer number from 1 to 3.

CnF₂ₙ₊₁(CH₂)ₘSiX¹ₐX²₍₃₋ₐ₎ (2)

An example of X¹ in CₙF₂ₙ₊₁(CH₂)ₘ is a functional group for forming an alkoxy group, chlorine radical, a Si—O—Si bond, and the like, and X¹ is hydrolyzed with water to be removed as alcohol or acid. Examples of the alkoxy group includes: a methoxy group, an ethoxy group, an n-propoxy group, an isopropoxy group, an n-butoxy group, an isobutoxy group, a sec-butoxy group, and a tert-butoxy group.

The number of carbons of R² is preferably within a range from 1 to 4 from the point of view that alcohol to be removed has a relatively small molecular amount so as to be able to be easily removed and therefore density of a film to be formed can be prevented from being lowered.

By using the alkylsilane compound containing fluorine, each compound is oriented such that the fluoroalkyl group is placed on a surface of a film to form a self-assembled film. Thus, a lyophobic property can be evenly given to the surface of the film.

Specifically, examples of the compound can include: CF₃—CH₂CH₂—Si(OCH₃)₃, CF₃(CF₂)₃—CH₂CH₂—Si(OCH₃)₃, CF₃(CF₂)₅—CH₂CH₂—Si(OCH₃)₃, CF₃(CF₂)₅—CH₂CH₂—Si(OC₂H₅)₃, CF₃(CF₂)₇—CH₂CH₂—Si(OCH₃)₃, CF₃(CF₂)₁₁—CH₂CH₂—Si(OC₂H₅)₃, CF₃(CF₂)₃—CH₂CH₂—Si(CH₃)(OCH₃)₂, CF₃(CF₂)₇—CH₂CH₂—Si(CH₃)(OCH₃)₂, CF₃(CF₂)₈—CH₂CH₂—Si(CH₃)(OC₂H₅)₂, and CF₃(CF₂)₈—CH₂CH₂—Si(C₂H₅)(OC₂H₅)₂.

In a case where the lyophobic part H is made of a fluorine resin, a liquid material obtained by dissolving a predetermined amount of a fluorine resin in a predetermined solvent is used. In particular, “EGC1720” (in which a fluorine resin is dissolved in a hydrofluoroether (HFE) solvent at 0.1 wt %) produced by Sumitomo 3M Limited can be used. In this case, an alcohol-, hydrocarbon-, ketone-, ether-, or ester-solvent is adequately mixed with HFE, so that the liquid material can be adjusted to be able to be discharged stably from the droplet discharge head 301. Alternatively, “LUMIFLON” (which can be dissolved in various solvents) produced by Asahi Glass Co., Ltd., “OPTOOL” (solvent: PFC, HFE, for example) produced by Daikin Industries. Ltd., and “DICGUARD” (solvent: toluene, water and ethylene glycol) produced by Dainippon Ink And Chemicals, Incorporated can be used as a fluorine resin.

Further, a resin of which a side chain includes an F group, —CF₃, —CF₂—, —CF₂CF₃, —(CF₂)ₙCF₃, and —CF₂CFC1— can be used as a resin containing fluorine.

Then, as shown in FIGS. 4A and 4B, lyophobic droplets L containing the lyophobic material described above is constantly discharged from the droplet discharge head 301 to each of the lyophobic parts H (a first step).

At this time, in each of the lyophobic parts H, the lyophobic droplets L are discharged and applied to land on the surface Pa of the substrate P such that the droplets L adjacent each other are overlapped. Thus, each of the lyophobic parts H is formed by one scanning of the droplet discharge head 301 with respect to the substrate P.

Here, as shown in FIG. 3A, a width WA of the wiring pattern W is determined by the difference between an arrangement pitch HP and a width HA of the lyophobic parts H. Since the arrangement pitch HP is determined as a specification of the wiring pattern W, the width WA of the wiring pattern W depends on the width HA of the lyophobic parts H. The width HA of the lyophobic parts H is regulated by the discharge amount of the lyophobic droplets L discharged from the droplet discharge head 301 and a discharge pitch LP shown in FIG. 4A in the present embodiment.

In particular, two discharge amounts La and Lb of the droplets L are set such that the La is 2.5 μl and the Lb is 4.5 μl, for example. Then, the droplets L in respective discharge amounts La and Lb are discharged and applied at discharge pitches LP of 10, 20, and 30 μm respectively, and thus widths HA of the lyophobic parts H formed on the substrate P are maintained as a table corresponding to the discharge amounts and the discharge pitches LP. When the lyophobic parts H having a desired width HA are formed, a discharge amount and a discharge pitch LP corresponding to the width HA are called up from the table. Thus droplets L are discharged at the discharge amount and the discharge pitch LP that are called up, in a discharging step of the lyophobic droplet.

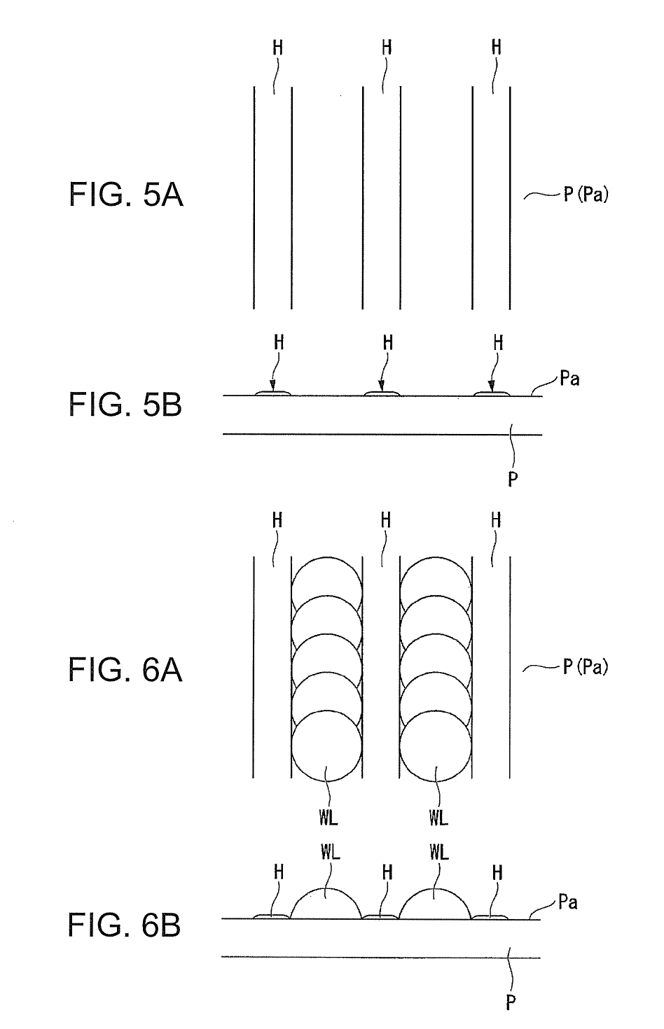

Then the lyophobic droplets L that are discharged on the substrate P are pre-dried, so that the lyophobic parts H that have a linear shape and have a thickness of several nm to dozens nm are formed on the substrate P with a gap therebetween, as shown in FIGS. 5A and 5B.

These lyophobic parts H made of the lyophobic material described above have a contact angle of 50 degrees or more with respect to the droplet for a pattern. Therefore, a contrast between the lyophilic part (surface) Pa and the lyophobic part H (difference between the contact angles) is 30 degrees or more.

(Material Disposing Step)

Next, the droplet for a pattern is discharged between the lyophobic parts H on the surface Pa of the substrate P so as to form the wiring pattern W.

A material for forming the wiring pattern is generally a dispersion liquid in which a conductive fine particle is dispersed. Examples of the conductive fine particle include: metal fine particles including any of gold, silver, cupper, palladium, nickel, and ITO, and oxides of these materials, and fine particles of a conductive polymer and a super-conductive material, in the present embodiment.

These conductive fine particles may be used in such manner that their surfaces are coated with an organic matter or the like to improve their dispersibility.

The diameter of the conductive fine particle is preferably in the range from 1 nm to 0.1 μm. A particle having a diameter larger than 0.1 μm may cause clogging of the discharge nozzle of the droplet discharge head. On the other hand, a particle having a diameter smaller than 1 nm may make the volume ratio of a coating agent with respect to the conductive fine particle so large that the ratio of an organic matter in the resulting film becomes excessive.

Here, any dispersion medium can be used as long as it is capable of dispersing the above-described conductive fine particles and does not cause an aggregation. Examples of the dispersion medium may include: water; alcohols such as methanol, ethanol, propanol, and butanol; hydro-carbon compounds such as n-heptane, n-octane, decane, dodecane, tetradecane, toluene, xylene, cymene, durene, indene, dipentene, tetrahydronaphthalene, decahydronaphthalene, and cyclohexylbenzene; ether compounds such as ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis(2-methoxyethyl)ether, and p-dioxane; and polar compounds such as propylene carbonate, gamma-butyrolactone, N-methyl-2-pyrrolidone, dimethylformamide, dimethyl sulfoxide, and cyclohexanone. Among these, water, alcohols, hydrocarbon compounds, and ether compounds are preferable for the dispersion medium, from points of view of: dispersibility of the fine particles, stability of a dispersion liquid, and an ease of the application to the droplet discharging method (inkjet method), and water and hydrocarbon compounds are more preferable.

In a case where the lyophobic parts H are formed with a silane compound or a compound including a fluoroalkyl group (for example, a case of using octadecyltriethoxysilane (ODS)), a polar solvent is preferably used as a solvent (dispersion medium) so as to express a sufficient lyophobic property with respect to the droplet for a pattern. In particular, examples of the polar solvent include an organic solvent and an inorganic solvent such as water; alcohol like methanol and ethanol that are compatible with water; N,N-dimethylformamide (DMF); N-methylpyrrodidone (NMP); dimethylimidazoline (DMI); and dimethylsulfoxide (DMSO). A commixture adequately mixed two or more of these materials is also applicable.

The surface tension of the dispersion liquid containing the conductive fine particle is preferably within the range from 0.02 N/m to 0.07 N/m inclusive. If the surface tension is below 0.02 N/m when the liquid is discharged by ink-jetting, the wettability of an ink composition with respect to a nozzle surface is increased, rendering it likely to cause a flight curve. On the other hand, if the surface tension exceeds 0.07 N/m, a meniscus shape at the tip of the nozzle is unstable, rendering controlling the discharge amount and discharge timing hard. In order to adjust the surface tension, a fluorine-, silicone- or nonionic-based surface tension adjuster, for example, may be added in a small amount to the dispersion liquid at an extent not largely lowering a contact angle with respect to a substrate. The nonionic surface tension adjuster enhances the wettability of a liquid with respect to a substrate, improves the leveling property of a film, and prevents the occurrence of minute concavities and convexity of the film. The surface tension adjuster may include, as necessary, organic compounds such as alcohol, ether, ester, and ketone.

The viscosity of the dispersion liquid is preferably within the range from 1 mPa·s to 50 mPa·s inclusive. In discharging a liquid material as a droplet by ink-jetting, ink having a viscosity lower than 1 mPa·s may contaminate the periphery of a nozzle due to ink leakage. On the other hand, ink having a viscosity higher than 50 mPa·s may disadvantageously cause a nozzle clogging, making it difficult to discharge droplets smoothly.

Then, as shown in FIGS. 6A and 6B, a droplet WL for a pattern containing above-mentioned material for forming the wiring pattern is constantly discharged from the droplet discharge head 301 to gaps between the lyophobic parts H (a second step). In particular, along a longitudinal direction (a direction to form the wiring pattern) of the lyophobic parts H (of the lyophilic part Pa), a plurality of droplets WL for a pattern are discharged at a predetermined pitch while relatively moving the droplet discharge head 301 with respect to the substrate P.

Since the contact angle of the surface Pa of the substrate P is 20 degrees or less with respect to the droplets WL, the droplets WL that are applied and spread between the lyophobic parts H without being separated or causing a bulge. Further, since the difference (contrast) between the contact angle of the lyophobic parts H and that of the surface Pa with respect to the droplets WL is 30 degrees or more, the droplets WL are repelled from the lyophobic parts H based on the difference of the wettabilities so as to be led and accumulate on the surface Pa between the lyophobic parts H. The contrast of 30 degrees or more is enough, but the contrast of 35 degrees or more is more preferable in a case considering a working example described later.

Further, since the lyophobic parts H descried above have a small thickness of several nm to dozens nm, they have no function as a separation wall that decides a position of the droplets WL that are applied. The droplets WL are disposed on the lyophilic part Pa due to the difference of the contact angles (wettabilities) described above.

(Heat Treatment/Light Treatment Step)

In a heat treatment/light treatment step, the dispersion medium or the coating agent contained in the droplets that are disposed on the substrate is removed. Namely, the dispersion medium in the liquid material for forming a conductive film that is disposed on the substrate needs to be thoroughly removed in order to make electrical contact between fine particles secured. If a coating agent such as an organic substance is coated on the surface of a conductive fine particle in order to improve the dispersibility, the coating agent needs to be removed, as well.

The heat treatment and/or the light treatment are/is usually carried out in the atmosphere. If necessary, they can also be carried out in an environment of an inert gas such as nitrogen, argon, and helium. The temperature for the heat and/or light treatment is appropriately set depending on a boiling point (vapor pressure) of the disperse medium, a type and pressure of an atmospheric gas, thermal behavioral properties including particle dispersibility and oxidizability, presence and a volume of the coating material, and a heat resistance temperature of a base material, for example.

For example, eliminating a coating material made of an organic substance requires firing at about 300 degrees Celsius. When a plastic substrate, for example, is used, the firing is preferably carried out in a temperature range from room temperature to 100 degrees Celsius inclusive. The substrate is fired at a temperature of 250 degrees Celsius for 60 minutes in this embodiment.

The heat and/or light treatment may be carried out by lamp annealing as well as an ordinary heating treatment employing a heating means such as a hotplate and an electric furnace. Light sources for lamp annealing are not limited but examples thereof can include: an infrared lamp, a xenon lamp, YAG laser, argon laser, carbon dioxide laser, and excimer laser of XeF, XeCl, XeBr, KrF, KrCl, ArF, ArCl, or the like. For such light sources, a light source having a power within the range from 10 W to 5000 W is typically used, but in the present embodiment, a power within the range from 100 W to 1000 W is adequate.

By the heat and/or light treatment described above, the electrical contact between the fine particles is secured, so that the liquid material is converted into a conductive film.

Through the steps described above, the wiring pattern W shown in FIG. 3A is formed on the substrate P.

### Working Examples

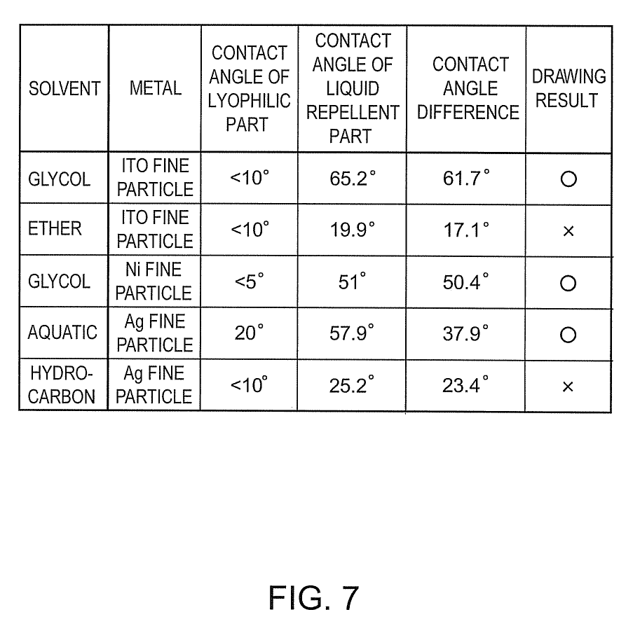

FIG. 7 shows relations of: contact angles of the lyophobic part H and the lyophilic part Pa; contrasts; and drawing results obtained under the following conditions: the width HA of the lyophobic part H of 100 μm and the width WA of the wiring pattern W of 40 μm, when solvents and metals were set to be: a glycol solvent and ITO; an ether solvent and ITO; a glycol solvent and Ni; an aquatic solvent and Ag; and a hydrocarbon solvent and Ag.

As shown in the table, when the contact angle of the lyophilic part was 20 degrees or less, no bulge occurred. When the contact angle of the lyophobic part was 50 degrees or more and the contrast was 30 degrees (preferably, 35 degrees) or more, a wiring pattern having a preferable evenness could be formed.

As described above, the present embodiment patterns and forms the lyophobic parts H by applying the lyophobic droplets L containing a silane compound, a compound including a fluoroalkyl group, and a fluorine resin, for example. Thus, the embodiment requires no expensive exposure device, photo mask, laser light source, and the like, being able to prevent a cost increase. Further, in the present embodiment, the width HA of the lyophobic parts H, that is, the width of the wiring pattern W can be easily adjusted by adjusting the discharge amount and the discharge pitch of the lyophobic droplets L. Especially, the present embodiment employs the table showing the correlative relationship between the discharge amount and the discharge pitch; and the width HA of the lyophobic parts H. Therefore, a discharge amount and a discharge pitch of the lyophobic droplets L can be easily and rapidly selected corresponding to the width WA of the wiring pattern W to be formed, being able to improve the productivity.

In the present embodiment, the lyophobic droplets L are discharged and applied to land on the surface Pa of the substrate P such that the droplets L adjacent each other are overlapped. Therefore, each of the lyophobic parts H can be formed by one scanning of the droplet discharge head 301 with respect to the substrate P, being able to further improve the productivity.

In addition, in the present embodiment, both of the lyophobic part forming step and the material disposing step can be carried out by droplet discharge, so that facilities required for the steps can be shared, being able to decrease the production cost.

### Second Embodiment

(Electro-Optical Device)

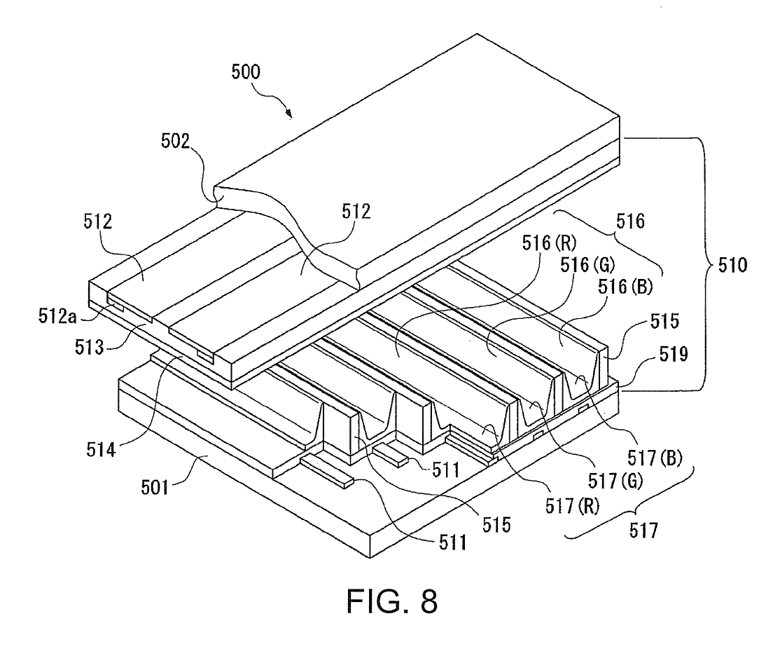

A plasma display that is an example of an electro-optical device manufactured by using the method for forming a pattern described above will be described with reference to FIGS. 8 to 11B.

FIG. 8 is an exploded perspective view showing a plasma display device 500 (an electro-optical device) of a second embodiment.

The plasma display device 500 includes glass substrates 501 and 502 arranged facing each other, and an electric discharge display unit 510 interposed between them.

On the top surface of the glass substrate 501, address electrodes 511 are formed in a stripe shape at a predetermined spacing, and a dielectric layer 519 is formed in a manner covering the top surfaces of the address electrodes 511 and the glass substrate 501. On the dielectric layer 519, partition walls 515 are formed so as to be located between and parallel with the address electrodes 511. Inside the stripe-shape regions delimited by the partition walls 515, phosphors 517 are provided. Each of the phosphors 517 emits any one of fluorescents of red, green, and blue. A red phosphor 517 (R) is provided on the bottom and sides of a red electric discharge chamber 516 (R), a green phosphor 517 (G) on the bottom and sides of a green electric discharge chamber 516 (G), and a blue phosphor 517 (B) on the bottom and sides of a blue electric discharge chamber 516 (B).

On the other hand, on the glass substrate 502, display electrodes 512 and bus electrodes 512a are provided. The display electrodes 512 are composed of a plurality of transparent conductive films and formed in a stripe shape at a predetermined spacing in a direction orthogonal to the address electrodes 511 mentioned above. The bus electrodes 512a are formed on the display electrodes 512 in order to supplement the display electrodes 512 that have high resistance. Covering the display electrodes 512 and the bus electrodes 512a, a dielectric layer 513 and a protective film 514 are formed in this order. The protective film 514 is made of MgO or the like.

The glass substrate 501 and the glass substrate 502 are bonded to face each other in such a manner that the address electrodes 511 and the display electrodes 512 cross each other orthogonally.

The electric discharge display unit 510 includes a plurality of electric discharge chambers 516. The plurality of electric discharge chambers 516 are arranged such that one pixel is composed of a region including a set of the red electric discharge chamber 516 (R), the green electric discharge chamber 516 (G) and the blue electric discharge chamber 516 (B), and surrounded by a pair of display electrodes.

The address electrodes 511 and the display electrodes 512 are coupled to an alternating current power source which is not shown in the drawings. By a current apply to each of the electrodes, the phosphors 517 in the electric discharge display unit 510 are excited to emit light, enabling a color display.

In the second embodiment, the display electrodes 512, the bus electrodes 512a, and the address electrodes 511 are formed by using the method for forming a pattern described in the first embodiment.

As is the case with the wiring pattern W described in the first embodiment, the address electrodes 511 are formed through the surface treatment step, the lyophobic part forming step, the material disposing step, and the heat and/or light treatment step with respect to the glass substrate 501. Therefore, the description thereof will be omitted.

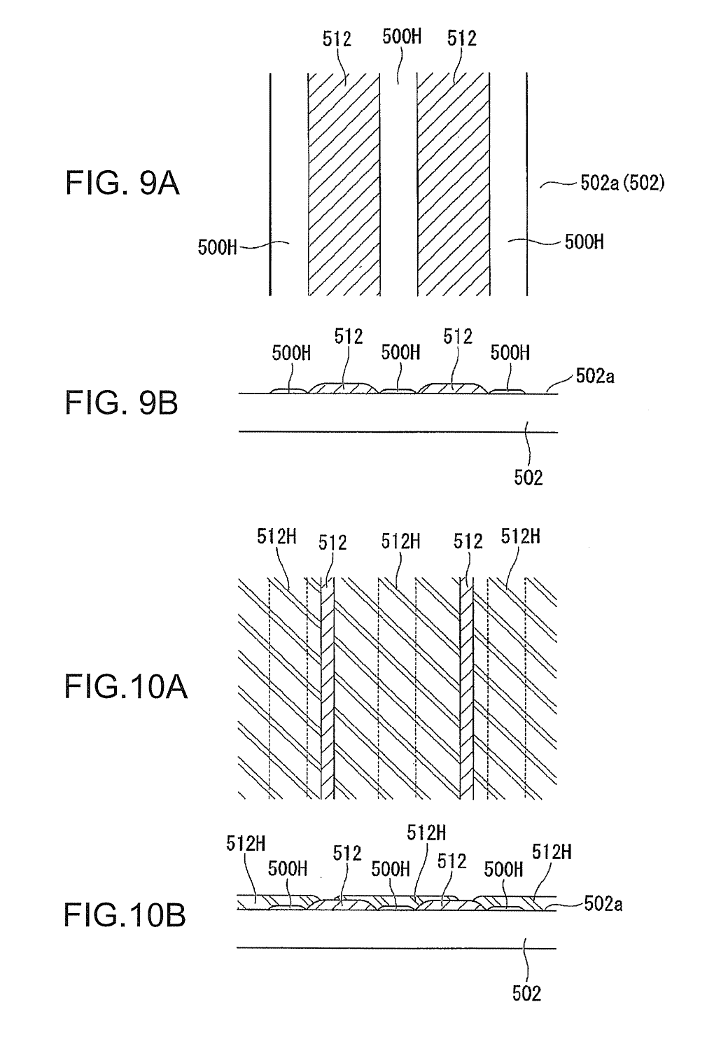

A process for forming the display electrodes 512 and the bus electrodes 512a will now be described with reference to FIGS. 9A to 11B.

In the same manner as the wiring pattern W described in the first embodiment, after the surface treatment is conducted with respect to a surface 502a that is a lyophilic part of the glass substrate 502 and is a first pattern forming surface, lyophobic parts 500H surrounding a region where the display electrodes 512 are to be provided are formed, as shown in FIGS. 9A and 9B. The lyophobic parts 500H are formed by discharging and applying a lyophobic droplet at a discharge amount of 2.5 pl and a discharge pitch of 50 μm, for example. The lyophobic droplet is obtained by mixing ODS described in the first embodiment with a commixture of aromatic hydrocarbon. Then droplets for a pattern containing ITO fine particles are discharged and applied to gaps formed between the lyophobic parts 500H and the substrate is fired at a temperature of 300 degrees Celsius for one hour. Thus the display electrodes 512 are formed. The lyophobic parts 500H are heated so as to remove the lyophobic property thereof.

As is the case with forming the lyophobic parts 500H, the lyophobic parts 512H are formed by discharging and applying lyophobic droplets to the glass substrate 502 provided with the display electrodes 512, in a manner surrounding (sandwiching) a region where the bus electrodes 512a are to be formed, as shown in FIGS. 10A and 10B. The lyophobic droplet that is obtained by mixing aforementioned ODS with a commixture of aromatic hydrocarbon. At this time, a part of the display electrodes 512 is exposed at the region where the bus electrodes 512a are to be formed.

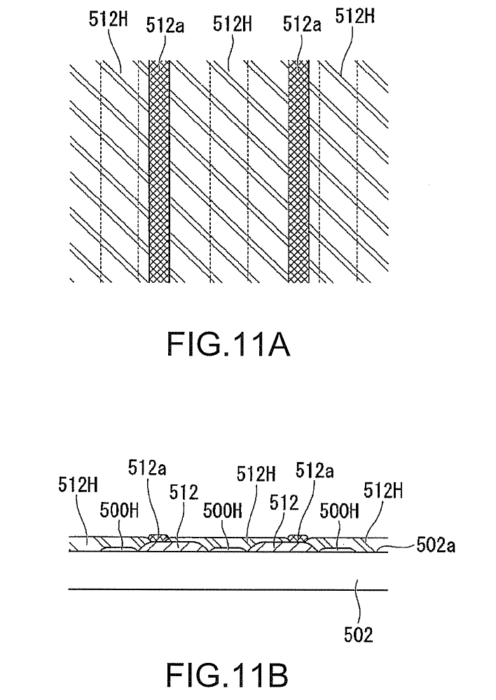

Then droplets for a pattern containing Ag fine particles are discharged and applied to the part of the display electrodes 512 exposed in gaps formed between the lyophobic parts 512H, and the substrate is fired at a temperature of 300 degrees Celsius for one hour. Thus the bus electrodes 512a communicating with the display electrodes 512 are formed as shown in FIGS. 11A and 11B.

In forming the display electrodes 512, the bus electrodes 512a, and the address electrodes 511, the widths of the lyophobic parts are determined by adjusting the discharge amount and the discharge pitch based on the table that is maintained so as to determine widths of the electrodes.

As described above, in this embodiment as well, patterns of the display electrodes 512, the bus electrodes 512a, the address electrodes 511, and the like can be formed without using an expensive exposure device, photo mask, laser light source, and the like, being able to prevent the cost increase. In addition, the discharge amount and the discharge pitch of the lyophobic droplets can be easily and rapidly selected correspondingly to a width of a pattern to be formed, improving the productivity.

Examples of the transparent conductive film forming material of the display electrodes 512 include: fine particles of at least one of component metals (indium, tin, antimony, aluminum, and zinc) of metal oxides for forming the transparent conductive film; fine particles of at least one alloy composed of two or more metals selected from the component metals; and mixed fine particles composed of these metal fine particles and the alloy fine particles, as well as ITO described above.

(Electromagnetic Wave Shield)

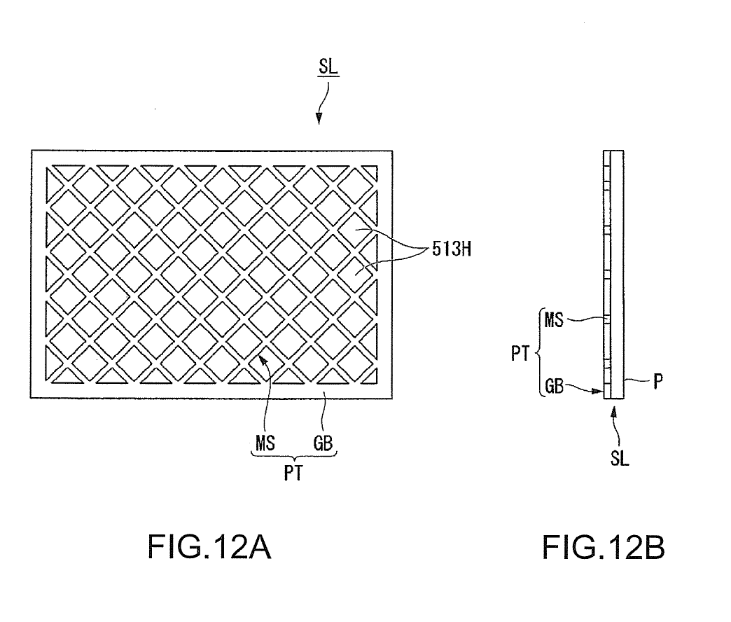

An electromagnetic wave shield that is an example of an electro-optical device manufactured by using the method for forming a pattern described above will be described with reference to FIGS. 12A and 12B.

FIG. 12A is a plan view of an electromagnetic wave shield, and FIG. 12B is a lateral view of the same.

In this electromagnetic wave shield (electro-optical device) SL shown in the drawings, a pattern PT is formed on a transparent substrate P made of transparent resin, a glass substrate, or the like, with a conductive wire.

The pattern PT includes a mesh part MS and a frame part GB. The mesh part MS is formed in a mesh shape in which a plurality of straight wires are arranged to cross each other with a gap therebetween. The frame part GB is formed around the periphery of the mesh part MS. Both of the mesh part MS and the frame part GB are made of the metals (Au, Ag, Cu, palladium, nickel, ITO, and the like) described above. If the wires constituting the mesh part MS have a large width, a shielding property improves, but the aperture ratio decreases. Therefore, the wires are set appropriately in accordance with a specification required as an electromagnetic wave shield SL. In the present embodiment, a wiring width is set to be 30 μm or less, and a wiring pitch is set to be 250 to 400 μm.

As is the case with the wiring pattern W in the first embodiment, the electromagnetic wave shield SL is formed through the surface treatment step, the lyophobic part forming step, the material disposing step, and the heat and/or light treatment step with respect to the transparent substrate P made of glass. In the lyophobic part forming step, lyophobic parts 513H are formed by discharging and applying lyophobic droplets to a region that is to be apertures of the mesh part MS at a discharge amount of 2.5 pl and a discharge pitch of 50 μm, for example, that are selected correspondingly to a width of a wire (that is, a width of a lyophilic part to be formed) of the mesh part MS to be formed. The lyophobic droplets are obtained by mixing ODS described above with a commixture of aromatic hydrocarbon. Then droplets containing the metal fine particles described above are discharged and applied to a lyophilic part (a surface of the glass substrate P) exposed at gaps formed between the lyophobic parts 513H at a discharge amount of 2.2 pl and a discharge pitch of 30 μm, for example. Then the substrate is fired at a temperature of 300 degrees Celsius for one hour. Accordingly, the electromagnetic wave shield SL including the mesh part MS and the frame part GB can be formed.

Such electromagnetic wave shield SL can decrease an effect of high frequency electromagnetic wave noise generated from electronic equipment, an image disturbance, and noise of a speaker as well as an adverse effect to a human body.

As described above, in the electromagnetic wave shield, the pattern PT of the mesh part MS and the frame part GB can be formed without using an expensive exposure device, photo mask, laser light source, and the like, being able to prevent the cost increase. In addition, the discharge amount and the discharge pitch of the lyophobic droplets can be easily and rapidly selected correspondingly to a width of a pattern to be formed, improving the productivity.

(Liquid Crystal Display)

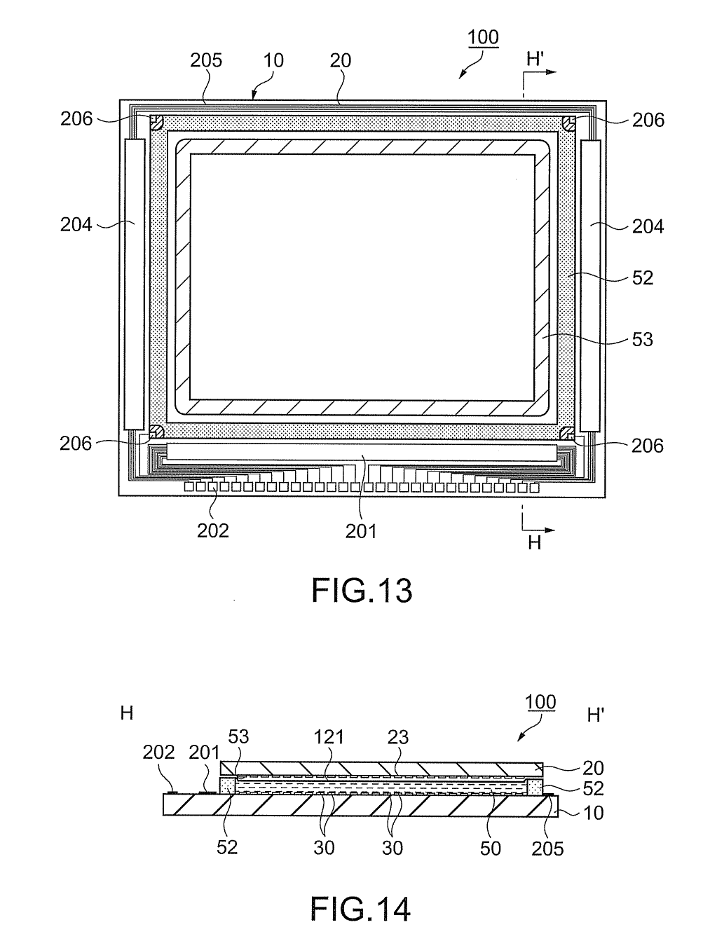

A liquid crystal display that is an example of an electro-optical device manufactured by using the method for forming a pattern described above will be described with reference to FIGS. 13 to 17.

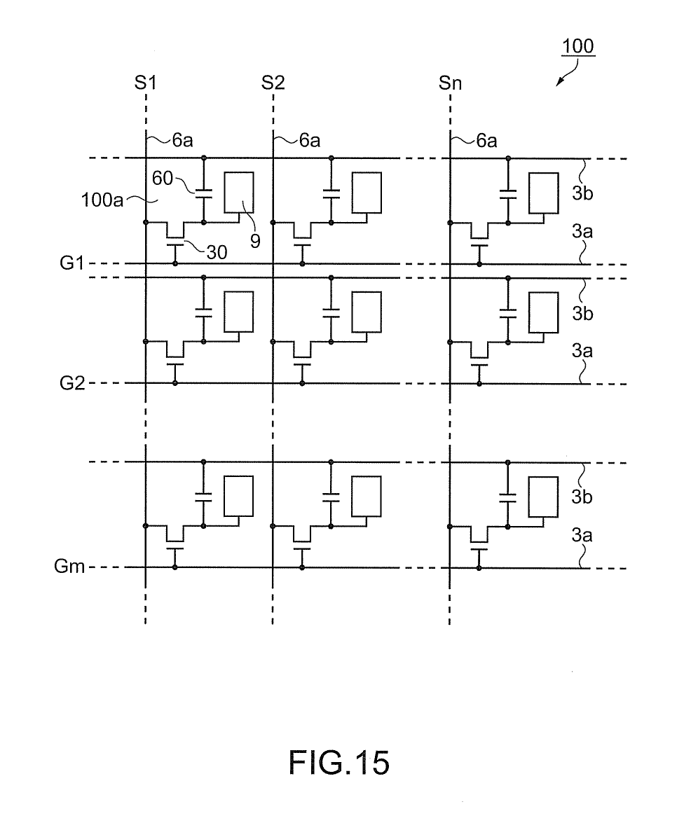

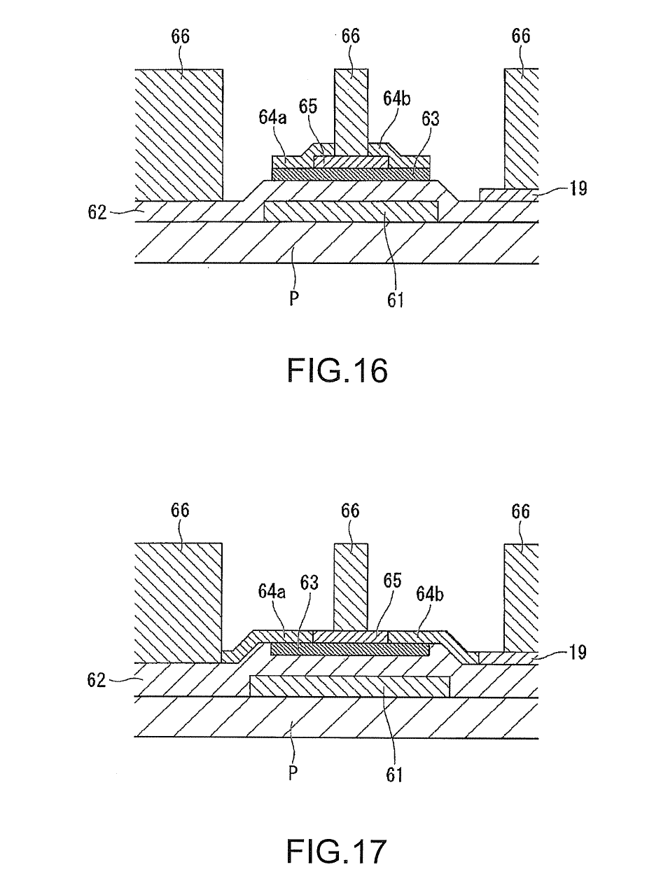

FIG. 13 is a plan view showing a liquid crystal display with each component viewed from a counter substrate. FIG. 14 is a sectional view taken along the line H-H′ of FIG. 13. FIG. 15 is an equivalent circuit diagram showing elements, wiring lines, etc., in a plurality of pixels arranged in a matrix in an image display area of the liquid crystal display. FIG. 16 is a partially enlarged sectional view of the liquid crystal display. It should be noted that different scales are used for layers and members in the accompanying drawings, so that they can be recognized.

Referring to FIGS. 13 and 14, in this liquid crystal display (electro-optical device) 100 of the embodiment, a TFT array substrate 10 and a counter substrate 20 are bonded as a pair with a photocuring sealant 52 interposed therebetween. In an area defined by the sealant 52, a liquid crystal 50 is sealed and retained. The sealant 52 is formed in a closed frame shape within a plane of the substrate. The sealant 52 has no liquid crystal injection inlet and no trace sealed with a sealing material.

In a region inside the area where the sealant 52 is provided, a peripheral light-blocking film 53 made of a light blocking material is provided. In an area outside the sealant 52, a data line driving circuit 201 and a mount terminal 202 are provided along one side of the TFT array substrate 10. Provided along two sides adjacent to the one side are scanning line driving circuits 204. Provided along another side of the TFT array substrate 10 are a plurality of wiring lines 205 to connect the scanning line driving circuits 204 provided to the both sides of an image display area. At one or more of corners of the counter substrate 20, an inter-substrate conductive material 206 is disposed to provide electrical conductivity between the TFT array substrate 10 and the counter substrate 20.

In this regard, instead of providing the data line driving circuit 201 and the scanning line driving circuits 204 on the TFT array substrate 10, a tape automated bonding (TAB) substrate on which a driving LSI is mounted and a group of terminals provided around the TFT array substrate 10 may be electrically and mechanically coupled with an anisotropic conductive film interposed therebetween. Note that a retardation film, a polarizer, etc., included in the liquid crystal display 100 are disposed in a predetermined direction (not shown) depending on the type of the liquid crystal 50 to be used, that is, operation modes such as a twisted nematic (TN) mode and a super twisted nematic (STN) mode; and a normally-white mode or a normally-black mode.

If the liquid crystal display 100 is provided as a color display, the counter substrate 20 is provided with red (R), green (G) and blue (B) color filters, for example, and their protective films in its area opposing to each pixel electrode described later of the TFT array substrate 10.

In the image display area of the liquid crystal display 100 having the above-described structure, as shown in FIG. 15, a plurality of pixels 100a are arranged in a matrix. Each of the pixels 100a is provided with a TFT (switching element) 30 for switching a pixel. To the source of the TFT 30, a data line 6a that supplies a pixel signal S1, S2, . . . , or Sn is electrically coupled. The pixel signals S1 through Sn to be written in the data lines 6a may be supplied sequentially in this order or with respect to each group of a plurality of adjacent data lines each corresponding to the data lines 6a. To the gate of the TFT 30, a scanning line 3a is electrically coupled. To the scanning line 3a, scanning signals G1, G2, . . . , or Gm is applied pulsatively and line-sequentially in this order at a predetermined timing.

A pixel electrode 9 is electrically coupled to the drain of the TFT 30. The TFT 30 that is a switching element is turned on for a certain period of time and thus the pixel signals S1 through Sn supplied from the data lines 6a are written in respective pixels at a predetermined timing. The pixel signals S1 through Sn, each of which is in a predetermined level and written in liquid crystal through the pixel electrode 9, are retained between a counter electrode 121 of the counter substrate 20 shown in FIG. 14 and the pixel electrode 9 for a certain period. In order to prevent a leak of the pixel signals S1 through Sn that are retained, a storage capacitor 60 is provided in parallel with a liquid crystal capacitor formed between the pixel electrode 9 and the counter electrode 121. For example, a voltage of the pixel electrode 9 is retained by the storage capacitor 60 for a period of time that is three orders of magnitude longer than the time for which a source voltage is applied. Consequently, an electron retention property improves, being able to provide the liquid crystal display 100 with a high contrast ratio.

FIG. 16 is a partially enlarged sectional view of the liquid crystal device 100 including the TFT 30 having a bottom-gate structure. On the substrate P made of glass and constituting the TFT array substrate 10, a gate wiring 61 is formed by the method for forming a pattern of the above embodiment.

On the gate wiring 61, a semiconductor layer 63 made of amorphous silicon (a-Si) is formed with a gate insulation film 62 made of SiNx interposed therebetween. The part, which faces the gate wiring, of the semiconductor layer 63 serves as a channel region. On the semiconductor layer 63, bonding layers 64a and 64b made of n+ type a-Si, for example, are formed in order to provide ohmic bonding. On the central part of the semiconductor layer 63, i.e. of the channel region, an insulative etch stop film 65 that is made of SiNX and protects the channel is formed. The gate insulation film 62, the semiconductor layer 63, and the etch stop film 65 are patterned as shown in the drawing through the following steps: vapor deposition (CVD), resist coating, exposure and development, and photo etching.

Further, the bonding layers 64a and 64b and a pixel electrode 19 made of ITO are formed and photo-etched in the same manner as the above, being patterned as shown in the drawing. Then banks 66 are projectingly provided on the pixel electrode 19, the gate insulation film 62, and the etch stop film 65. Between the banks 66, silver compound droplets are discharged with the droplet discharge device IJ described above so as to form source lines and drain lines.

Alternatively, as shown in FIG. 17, a recess is formed on the gate insulation film 62, and then the semiconductor layer 63 is formed in the recess in a manner being approximately coplanar to a surface of the gate insulation film 62. Then the bonding layers 64a and 64b, the pixel electrode 19, and the etch stop film 65 are formed thereon. In this case, if the bottom part of a groove between the banks 66 is formed approximately flat compared to that in FIG. 16, a flexural part of each of the above layers, the source lines, and the drain lines can be reduced, being able to provide a TFT having improved flatness to have high property.

As described above, the present embodiment can provide the liquid crystal display 100 that has high quality, is thinned, and can be highly integrated.

In the TFT structured as above, after the lyophobic droplet is applied to pattern the lyophobic part and the lyophilic part, the droplet of the silver compound, for example, is discharged to the lyophilic part. Thus the gate lines, the source lines, the drain lines, and the like are formed without using an expensive exposure device, photo mask, laser light source, and the like, being able to prevent the cost increase. In addition, the discharge amount and the discharge pitch of the lyophobic droplet can be easily and rapidly selected correspondingly to a width of a pattern to be formed, being able to improve the productivity.

While the TFT 30 serves as a switching element to drive the liquid crystal display 100 in the embodiment, it is also applicable for organic electroluminescence (EL) displays, for example. An EL display is an element in which a thin film containing fluorescent inorganic and organic compounds are sandwiched between a cathode and anode. By injecting electrons and holes into the thin film to recombine them and thus generate excitons, the element emits light by means of light emission (fluorescence/phosphorescence) as the excitons get deactivated. Among fluorescent materials used for an EL display element, materials exhibiting luminescent colors of red, green and blue, that is, materials for forming a light-emitting layer and a hole injection/electron transport layer are used as ink. The materials are patterned on a substrate including the TFT 30 so as to manufacture a light-emitting full color EL device.

The electro-optical device of the invention includes such organic EL device. Thus an organic EL device in which a desired property is realized and no faults such as short-circuit occurs can be obtained.

(Noncontact Card Medium)

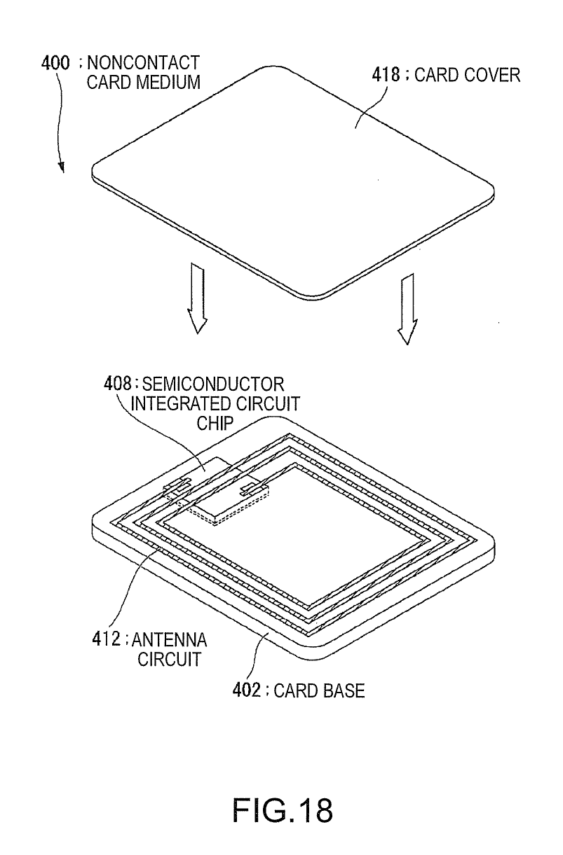

A noncontact card medium according to the embodiment will be next described. Referring to FIG. 18, this noncontact card medium (electronic apparatus) 400 includes a semiconductor integrated circuit chip 408 and an antenna circuit 412 housed in a case composed of a card base 402 and a card cover 418. The noncontact card medium supplies electric power and/or communicates data with an outside transceiver (not shown) by using at least one of electromagnetic waves and electrostatic capacity coupling.

In the noncontact card medium, the antenna circuit 412 is formed by the method for forming a pattern of the above-described embodiment.

Manufacturing a noncontact card medium of the present embodiment can prevent the cost increase and improve the productivity.

The electro-optical device of the embodiment also includes not only the above but also a surface-conduction electron emitter that uses a phenomenon of electron emission caused by applying an electrical current to a small thin film provided on a substrate in parallel with the surface of the film.

### Third Embodiment

(Electronic Device)

An electronic device according to a third embodiment of the invention will now be described.

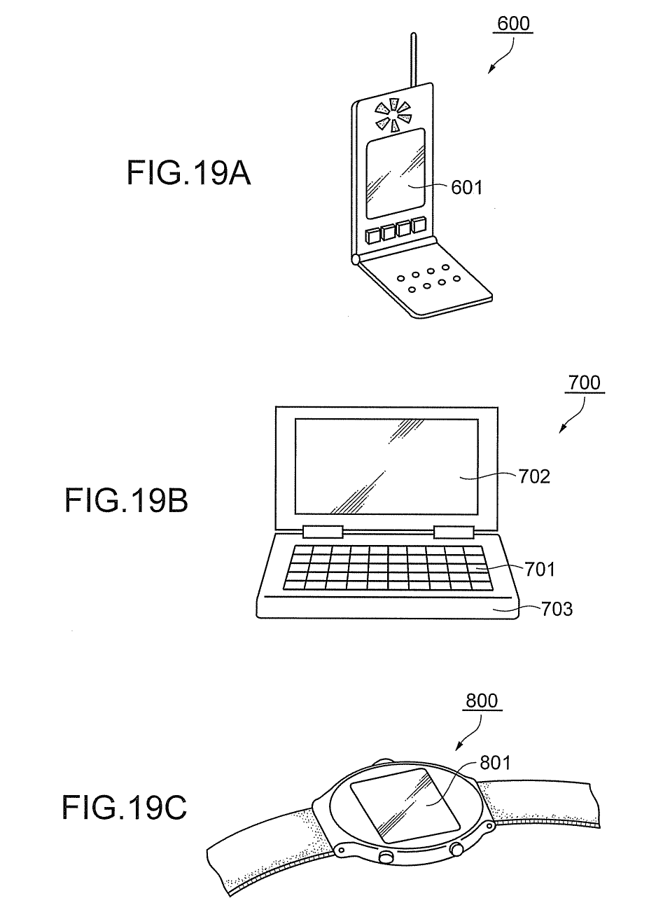

FIG. 19A is a perspective view illustrating a cellular phone. Referring to FIG. 19A, this cellular phone 600 includes a liquid crystal display unit 601 having the liquid crystal display described in the above-mentioned embodiment.

FIG. 19B is a perspective view illustrating a portable information processing device such as a word processor and personal computer. Referring to FIG. 19B, this information processing device 700 includes an input unit 701 such as a keyboard, an information processing body 703, and a liquid crystal display unit 702 having the liquid crystal display of the above-mentioned embodiment.

FIG. 19C is a perspective view illustrating a wristwatch electronic apparatus. Referring to FIG. 19C, this watch body 800 includes a liquid crystal display unit 801 having the liquid crystal display of the above-mentioned embodiment.

The electronic apparatuses shown in FIGS. 19A to 19C include the liquid crystal display of the above-mentioned embodiment, being able to prevent the cost increase and be manufactured with better productivity.

While the electronic apparatuses of the third embodiment are provided with a liquid crystal device, alternatively they can be provided with other electro-optical devices such as an organic electroluminescent display and a plasma display.

The preferred embodiments according to the invention are described with reference to the accompanying drawings as above, but it is understood that the invention is not limited to these embodiments. The shapes, the combinations or the like of the members described in the above embodiments are an example, and various modifications can be made based on a design demand or the like without departing from the scope of the invention.

For example, while the above embodiments describe the liquid containing a conductive material as a functional liquid, the functional liquid means a liquid including metal, semiconductor, ceramics, organic material, pigment, and optical material and being used for providing a thin film such that it is disposed on a desired position of a substrate and is fired. The function includes conductivity, insulation property, semiconductor property, light collection property, photoselective absorption, luminescence property such as fluorescence and phosphorescence, and orientation control of liquid crystal particles.

Above-mentioned embodiments describe that the wiring lines are formed with the functional liquid, but the invention is not limited to it. For example, a droplet containing a plating catalyst material such as palladium may be applied so as to form a plating catalyst film. In this case, by conducting a plating treatment in a post process, a wiring (Cu, for example) having high density can be easily and inexpensively formed.

Further, the above-mentioned embodiments describe that the cleaning treatment is conducted with respect to the substrate P so as to enhance the lyophilic property thereof as the surface treatment step, but the invention is not limited to this. For example, a silane coupling agent or a titanium coupling agent that expresses lyophilic property with respect to the functional liquid (droplet for a pattern) or a titanium oxide particle may be applied to the surface Pa.

What is claimed is:

1. A method for forming a pattern, comprising:
a) applying a droplet containing a lyophobic material to a substrate having a lyophilic part, the lyophilic part being lyophillic with respect to a functional liquid, so as to form a lyophobic part, the lyophobic part being lyophobic with respect to the functional liquid and including a plurality of lyophobic parts; and
b) applying the functional liquid to the lyophilic part positioned between the lyophobic parts, wherein
the lyophobic material includes at least one of a silane compound, a compound including a fluoroalkyl group, and a resin containing fluorine.

2. The method for forming a pattern according to claim 1, wherein the lyophobic material is a resin containing fluorine in a side chain thereof.

3. The method for forming a pattern according to claim 1, wherein the silane compound is a self-assembled film.

4. The method for forming a pattern according to claim 1, wherein the lyophobic part is formed on a surface of the substrate with a self-assembled film that is made of a compound including the fluoroalkyl group.

5. The method for forming a pattern according to claim 1, wherein the lyophobic part is formed on the surface of the substrate with a self-assembled film including an alkyl group and hydrogen.

6. The method for forming a pattern according to claim 1, wherein the functional liquid is a liquid material obtained by dissolving a pattern forming material in a polar solvent.

7. The method for forming a pattern according to claim 1, wherein in the step b), a droplet of the functional liquid is applied to the lyophilic part.

8. The method for forming a pattern according to claim 1, wherein the functional liquid contains a conductive material.

9. The method for forming a pattern according to claim 8, wherein the conductive material contains at least one of gold, silver, copper, palladium, nickel, and indium tin oxide.

10. The method for forming a pattern according to claim 1, wherein the functional liquid contains a plating catalyst material.

11. A method for manufacturing an electro-optical device, comprising forming a pattern by the method for forming a pattern according to claim 1.

12. The method for manufacturing an electro-optical device according to claim 11, wherein the electro-optical device is an electromagnetic wave shield including a mesh part that is formed in a mesh shape with a conductive wire and a frame part that is formed around a periphery of the mesh part with the conductive wire, and the mesh part and the frame part are formed by the method for forming a pattern.

13. A method for manufacturing an electronic device, comprising forming a pattern by the method for forming a pattern according to claim 1.
